(19) United States
(12) Patent Application Publication
(10) Pub. No.: US 2008/0298204 A1
(43) Pub. Date: Dec. 4, 2008

(54) Optical disc drive apparatus

(75) Inventor: Naohito Ikeda, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignees: Hitachi, Ltd., Tokyo (JP); Hitachi-LG Data Storage, Inc., Tokyo (JP)

(21) Appl. No.: 12/080,110

(22) Filed: Mar. 31, 2008

(30) Foreign Application Priority Data
May 31, 2007 (JP) 2007-144358

(51) Int. Cl. G11B 3/74

(52) U.S. Cl. 369/94

(57) ABSTRACT

An optical disc drive apparatus, for recording/reproducing upon/from an optical disc medium having a plural number of recording layers, comprises a recording/reproducing element, which is configured to irradiate a laser upon the optical disc medium, to as to conduct recording/reproducing thereon/from, wherein recording is conducted within a region of an arbitrary range on the optical disc medium by means of the recording/reproducing element, and the region is used for moving an optical spot of the laser irradiated from the recording/reproducing element when recording/reproducing data thereon/from.

### BACKGROUND OF THE INVENTION

The present invention relates to a technology for shifting among layers of an optical disc having plural numbers of data recording layers, upon/from which data can be recorded/reproduced.

For example, in the following Patent Document 1 is described a technology “for enabling to decide layers, with certainty, but without a great increase of circuitry or necessity of a long waiting time due to retrying, by applying FSK method or PSK method, each having high modulating performances as a wobble modulation method, and also enabling to use the modulation circuit in common”.

[Patent Document 1] Japanese Patent Laying-Open No. 2005-85437 (2005)

### BRIEF SUMMARY OF THE INVENTION

In recent years, accompanying with spreading of Hi-Vision (i.e., high-definition televising) video broadcasting, etc., advancement is made on an optical disc to be endurable with storing said video data thereon, and upon an increase of recording capacity thereof. As a means for increasing the recording capacity of the optical disc is already known a method of disposing the data recording layers, each being recordable/reproducible, on one (1) piece of the optical disc, and with this, advancement is made on developments of an optical disc for increasing the recording capacity thereof.

Upon using such the optical disc having the data recording layers in plural numbers thereof, each being recordable/reproducible of data, as was mentioned above (hereinafter, being called “multi-layers disc”), there is necessity of a servo technology for focusing a spot of a laser light upon a target layer, as a process for moving across or shifting among the layers when recording/reproducing data.

As a method for bring an optic spot onto the focusing position of the target layer and for keeping that focusing position, it is common to apply a focus servo control, wherein a focus error signal is produced, being indicative of a shifting amount or volume of the focusing potion of the optical spot to the target layer, thereby conducting a feedback control upon that signal.

With the well-known method, since the focus error signal describes “S”-shaped curve when the optical spot comes across the vicinity of the target layer, then this phenomenon is used therein. Thus, when drawing the optical spot from the non-focusing condition into a focusing condition, the position of a recording/reproducing element emitting the laser therefrom is controlled fitting to the timing when the “S”-shaped curve enters into a linear area thereof, or when it comes cross zero, thereby drawing the optical spot into the focus position. Thereafter, a normal feedback control is conducted so as to keep it at the focus position.

Or, when shifting the layers for recording/reproducing in case of the multi-layer disc, the recording/reproducing element is so moved that the optical spot of the laser focusing on the target layer relaying on the “S”-shaped curve, which appears when shifting the optical spot from a present layer to the target layer. For this reason, in order to move to the layer of the target, with certainty, quality and reliability of the “S”-shaped curve is important, which appears when moving the optical spot.

However, a case can be considered where the optical spot comes across upon the same layer, in particular, when movement of the disc surface is large, and there is a possibility of detecting a number of the “S”-shaped curves, but being larger than that of the “S”-shaped curves that should be detected, naturally, when it moves on the layers.

When such phenomenon occurs, due to erroneous detection of the number of the “S”-shaped curves, there may be a case where the optical spot actually moves to the layer differing from the target layer, in the expectation that it moves to that target layer.

Due to such the example as was mentioned above, on the multi-layer disc, it is necessary to ascertain on whether the layer, to which the optical spot reaches or arrives, is the target layer or not, during the movement among the layers when recording/reproducing the data thereon/from.

As a means for ascertaining on whether the layer arriving at after movement of layers is the target layer thereof or not, there is already known a method of obtaining address information of the optical disc on the layer that the optical spot reaches or arrives, so as to ascertain on whether the address obtained is the address of that target layer or not. The address information of the optical disc is berried or embedded within the wobble structures, i.e., wobbling a guide groove of the optical disc at a certain period. Therefore, in order to obtain the address information of the optical disc, it is sufficient to obtain a wobble signal, which can be obtained from the wobble structures mentioned above. For that purpose, in particular, when moving across the layers, there is a necessity of preparation for detecting the wobble signal, with stability, from the layer, upon which the focusing is made; i.e., bringing the servo into a stable condition through a tracking control, i.e., a servo-control in the direction of the disc radius.

With the technology of the Patent Document 1, a special wobble is berried or embedded on a whole surface of the disc, and therefore needing changes of physical structures of the disc. For that reason, for the purpose of supporting the optical disc applying the technology of the Patent Document 1 therein, there is a necessity of newly coping with the physical structures, which are changed by taking the technology of the Patent Document 1 therein. Or, an optical disc drive apparatus, which is already sold before taking the technology of the Patent Document 1 therein, is not always in the specification of enabling the optical disc having such the specific physical structures mentioned above; therefore, it is difficult to maintain a compatibility between the optical disc drive apparatus and the optical disc.

Or, with the method of detecting the address information or the layer information from the wobble, as is representatively shown in the Patent Document 1, since it is always necessary to conduct the tracking control, after focusing on the target layer, so as to detect the wobble signal, and therefore, there is a necessity of a time period, for stabilizing the servo.

The present invention, for dissolving such the problems as mentioned above, and an object thereof is to provide an optical disc drive apparatus, for detecting an error, between the arrival layer and the target layer, with high speed and certainty, when moving across the layers, but without changing the physical structures of the existing optical disc medium, in particular, on the multi-layer disc.

Further, the present invention enables to increase a possibility of reaching to or arriving at the target layer, when moving across the layers.

According to the present invention, recording is made within a range of an arbitrary region, on the multi-layer disc, and the said region is used for processing of moving the optical spot across the layers when recording/reproducing data thereon/from, and determination on whether the movement is made to the target layer, correctly, or not.

Or, the region, which is used for the said moving the optical spot across the layer, is registered logically, on the optical disc, to be an un-recordable region.

According to the present invention mentioned above, it is possible to execute confirmation on whether the optical spot can move to the target layer or not when moving the optical spot across the layers, with high speed and certainty, when recording/reproducing data onto/from the multi-layer disc.

### BRIEF DESCRIPTION OF THE DRAWINGS

Those and other objects, features and advantages of the present invention will become more readily apparent from the following detailed description when taken in conjunction with the accompanying drawings wherein:

FIGS. 1A, 1B and 1C are views of an example of characteristic recording method on an optical disc, according to an embodiment of the present invention, wherein FIG. 1A shows an upper view of the optical disc medium, FIG. 1B a cross-section view of the optical disc medium, and FIG. 3C an enlarged view of a portion attached with a reference numeral 102 in FIG. 1B;

FIG. 2 is a graph for showing a way of appearance of a “S”-shaped curve on each of layers, upon the optical disc medium having four (4) layers;

FIG. 3 shows a general optical disc drive apparatus;

FIG. 4 is an example of flowchart for showing a method for moving an optical spot across layers, according to the present invention; and

FIG. 5 is an example of flowchart for showing the method for moving an optical spot across layers, with applying the present invention therein.

### DESCRIPTION OF THE PREFERRED EMBODIMENTS

Hereinafter, embodiments according to the present invention will be fully explained by referring to the attached drawings.

In accordance with the present invention, as a means for determining layers are produced different regions, each differing in the reflectivity, by irradiating a laser thereupon, but separating from a non-recorded portion, and those layers differing in the reflectivity are utilized, as an index for determining the layers.

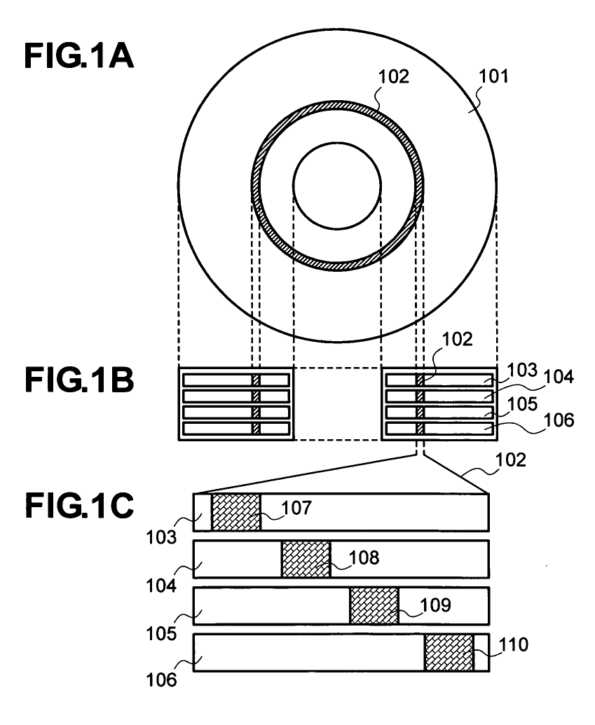

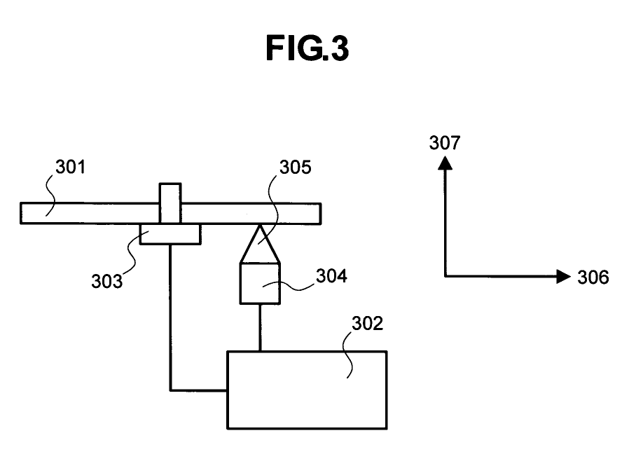

The embodiment mentioned above will be shown by referring to FIGS. 1A to 1C and FIG. 3. FIGS. 1A to 1C show the conventional optical disc medium, wherein FIG. 1A shows an upper view of the optical disc medium, FIG. 1B a cross-section view of the optical disc medium, and FIG. 1C an enlarged view of a region attached with a reference numeral 102 in FIG. 1B, i.e., the cross-section view of the optical disc medium. FIG. 3 is a view for showing a general optical disc drive apparatus, simply.

First of all, a method for producing the layers differing in the reflectivity from the non-recorded portion, within an arbitrary region, upon each of layers of the optical disc medium. This is done with a similar manner to that when recoding data on the optical disc medium. Hereinafter will be mentioned a general data recording method.

For the purpose of recording data in an arbitrary region of the optical disc medium 301, first a drive control system 302 controls a spindle mechanism 303, thereby rotating the optical disc medium 301. Then, the drive control system 302 controls a recording/reproducing element 304, so as to let a laser 305 to irradiate a light at a laser power lower than the laser power for use of recording. And, in accordance with recording position information (i.e., an address) on the optical disc medium 301, which is required from an exterior not shown in the figure, the recording/reproducing element 304 is controlled so that an optical spot of the laser 305 is located in the vicinity of a target position of recording. In this instance, the recording/reproducing element 304 is controlled, firstly, in the direction of an arrow 307, i.e., direction for focusing the optical disc medium 301 on a spot position of the laser 305, thereby conducting a focus servo control for focusing the optical spot on the target layer, and thereafter, in the direction of an arrow 306, i.e., direction of the radius of the optical disc medium 301, thereby conducting a tracking servo control for controlling the recording/reproducing element 304, following a rotation irregularity of the optical disc caused due to an eccentricity thereof when loading the optical disc. In this manner, by conducting both the focus servo control and the tracking servo control, a preparation is done for irradiating the laser, with stability, at an address of the target. Thereafter, the drive control system 302 controls the recording/reproducing element 304, so that the laser 305 irradiates a light at a power for recording, to add heat upon the optical disc medium 301 for changing the reflectivity of the optical disc medium 301, and thereby recoding desired data thereon.

As was mentioned above is the general data recording method onto the optical disc medium 301. According to the present invention, in the manner as was mentioned above, the characteristic recording is conducted on each of recording layers of the optical disc medium 101 shown in FIGS. 1A to 1C. Hereinafter will be shown the characteristic recording according to the present invention.

An example according to the present invention will be shown by using the optical disc medium 101 shown in FIGS. 1A to 1C. The characteristic recording is conducted by using an arbitrary area or region on the optical disc medium 101. The present example is one of using a certain region 102 in an arbitrary radius direction on the optical disc medium 101 as a region for the purpose of the present invention.

The optical disc medium 101 shown in FIGS. 1A to 1C, as an example of the multi-layer disc medium, is a disc having four (4) recording layers 103, 104, 105 and 106 thereon. In the present example, as is shown in FIG. 1B, the characteristic recording is conducted with using the certain region 102 in arbitrary radius direction, on each of the layers. It is presumed that the certain region 102 in arbitrary radius is in the non-recorded condition on every of the layers.

FIG. 1C a view for showing an enlarged portion of the certain region 102 in arbitrary radius direction, on the cross-section of the optical disc medium 101 shown in FIG. 1B. In the present example, within the certain region 102 in arbitrary radius direction is conducted recording, at a radius position on each of the layers. In the example shown in FIG. 1C, upon a layer 103 is conducted recording at the radius direction position, upon a layer 104 is conducted recording at the radius direction position 108, upon a layer 105 is conducted recording at the radius direction position 109, and upon a layer 106 is conducted recording at the radius direction position 110.

As is shown in FIG. 1C, within a predetermined region 102 in the radial direction is done the recording on each layer, characteristically, at the positions 107, 108, 109 and 110, differing from one another in the radial direction thereof.

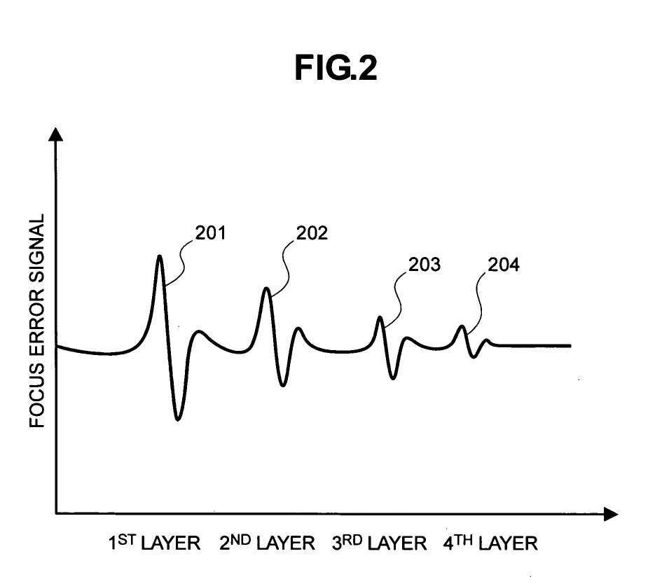

By the way, as was mentioned above, the movement across the layers for recording/reproducing depends on the quality of the “S”-shaped curve, and the difficulty also increases as the number of the layers increases on the multi-layer disc. FIG. 2 shows manners of appearances of the “S”-shaped curves, by numerical references 201, 202, 203 and 204, each of which can be observed when the optical spot comes across a first layer, a second layer, a third layer and a fourth layer, while scanning the optical spot in the direction of the layers under the condition of focusing it at a focus position of the first layer, upon the optical disc having four (4) recording layers. As is shown in FIG. 2, in case of the multi-layer discs, the focusing position of the optical spot is shifted due to the aberration, if the layers are separated too much in the distance therebetween, i.e., the present layer and the target layer, for example, and then deterioration becomes severe on the quality of the “S”-shaped curves, which appears when the optical spot comes across each layer, accompanying with an increase of the distance from the focus position thereof. Thus, at the time when the optical spot moves across the layer, it can be said that the severer the quality deterioration of the “S”-shaped curves, on the layer separating from the present focusing position, and that a possibility of succession of moving across layers is lowered down.

However, for the purpose of executing the present invention, it is presumed that, firstly such the characteristic recording is done as was mentioned above, and there is necessity of conducting that characteristic recording with certainty. Then, an example will be shown below, for executing that characteristic recording. Though FIG. 2 shows an example when focusing the optical spot on the first layer, but the deterioration is less on the signal quality of the “S”-shaped curves, on the second layer neighboring with the first layer, comparing to those of the third layer and the fourth layer. Therefore, for the purpose of executing that characteristic recording, the movement across layers is conducted by one (1) layer neighboring thereto, but not moving or jumping across a plural number of layers, once. For example, in order to execute the recording on 107, 108, 109 and 110, first of all, recording is done on 107 if it is under the condition where the optical spot is focused on the layer 103. Thereafter, the optical spot is focused on the layer 1-4, i.e., the neighboring layer, and after stabilization of the servo control, address information is read out on the layer, onto which the optical spot reaches, from a wobble, etc., for example. Thus, the recording is conducted after confirming that the optical spot is certainly focused upon the layer 104. In the similar manner, recording may be made at 109 and 110 while moving the optical spot onto the layers 105 and 106. Thus, as was shown in the present example, with conducting the record, but after certainly confirming that it is the neighboring layer through obtaining the address information, as was in the conventional method, it is possible to execute the characteristic recording, with certainty, i.e., the condition according to the present invention. However, the present example is only one example, and there is no necessity to adhere to this method, in particular, and also other methods can be applied if enabling that characteristic recording, in advance, for example.

As was mentioned above, first of all, that characteristic recording is cone, with certainty. And, according to the present invention, the movement across layers is conducted with using the region where that characteristic recording is conducted.

Herein, mentioning will be made about a power when recording, in particular, that characteristic recording, which is not explained clearly up to now. A purpose of the present recording lies to conduct the recording within a region where no recording is made (i.e., a non-recording region), with using the difference in the reflectivity from the region where the recording is already done (i.e., a recording region); i.e., for conducting a marking. Therefore, when conducting the characteristic recording, it is necessary to execute the recording with such power that the difference can be seen to a certain degree, on a level of reflection light, between the non-recording region and the recording region. However, in case when the recording power is high too much, there is a possibility of destroying the optical disc itself, therefore it is preferable to conduct that recording with an appropriate level of power. As a conventional process for determining the recording power for recording data on the optical disc medium, there is known a method, being called “OPC (Optimum Power Calibration), i.e., calculating out the appropriated recording power depending on the recording medium. The recording power when conducting the characteristic recording, according to the present invention, may also be conducted with an appropriate power, which can be calculated out fitting to the medium, upon which the recording is conducted with the OPC, etc. Or, if it is difficult to see or determine the level of reflection light, due to a reason of a detection system, then the power may be set higher than the power calculated upon that OPC, but a little bit, as far as it does not destroy the optical disc.

However, the present example is only an example, therefore the power may be changed depending on the condition of the detection system and/or the medium.

Further, a recording pattern will be mentioned, in particular, when conducting the characteristic recording. In the present recording, since it is enough to know the change on the reflectivity, then there is no necessity of conducting the recording, with using such patterns starting from a short mark to a long mark, as is when conducting the recording of normal user data, for example. For the purpose of enlarging the change of the reflectivity, the recording may be conducted with using a specific patter, which is made up with only a long mark. If conducting the recording with such the specific pattern, which is made up with only the long mark, for example, it is possible to determine that the region is not that for use of the user data, from a signal reproduced therefrom; and therefore, it is preferable to conduct the recording with using the specific patter, even in a sense of making that characteristic recording region clear.

However, the present example is only an example, and therefore it is also possible to change the recording pattern depending upon the conditions.

Next, mentioning will be made on the position where that characteristic recording is processed or treated. In FIG. 1, although that characteristic recording region is shown by a reference numeral 102, on the periphery of a center of the disc, but there is no necessity of disposing it only on the periphery of the center of the disc. Thus, no matter may be generated if it is within a region where the recording is allowed, according to a standard or regulation for the disc, and also within the region where no recording is made. However, there can be also considered that controlling may become easy, in particular, for an optical disc drive, for example, upon basis of elaboration made on the positions where the characteristic recording region is disposed. For example, disposing that characteristic recording region, fixedly, for example, on side of an inner periphery or an outer periphery of the disc, brings about simplicity, for example, in the positioning of the recording/reproducing element 304 and/or a sequence for moving the optical spot across layers, within the optical disc drive. In general, the recording/reproducing element 304 is restricted in the movement thereof, by an inner periphery sensor provided within the inner periphery side of the optical disc 301, into the inner periphery side thereafter. Using this fact, thus, combining this with the characteristic recording on the inner periphery side, it is possible to achieve the movement across layers, with a series of the following operations, i.e., firstly, moving the recording/reproducing element 304 up to when it is restricted by the inner periphery sensor, and thereafter positioning it within the predetermined region in the radial direction, where the characteristic recording is treated, laying in the inner periphery thereof, and thereby to move the optical spot across layers. Due to the fact of laying the characteristic recoding on the inner periphery side, it is possible to shorten the time-period until when completing the movement across layers after the recording/reproducing element 304 moves up to the limitation of that inner periphery sensor.

Or, preferably, the user data is recorded, continuously, within the user data region, in particular, when conducting continuous reproduction thereof. However, if having conducted the characteristic recording, according to the present invention, at a center of the user data region, there is a possibility that the user data is recorded crossing that characteristic recording region, in particular, when recoding continuous data within the user data region. When reproducing this data, there is necessity of crossing that recording region, on the way of the reproducing, and therefore, there can be caused a movement of the recording/reproducing element 304, when crossing over that characteristic region. This causes a possibility that an ill influence is generated in a reproducing speed of the optical disc drive. Even taking the example mentioned above into the consideration, it is preferable to dispose the region, where that characteristic recoding is conducted, is biasing to either the inner periphery or the outer periphery of the optical disc medium 301.

However, since the present example is only an example, and therefore, it does not matter to change the position of the predetermined region in the radial direction where the characteristic recording should be treated.

Next, mentioning will be made on a method for moving across layers and a method for determining layers, with using the predetermined region 102 in the radial direction, according to the present invention.

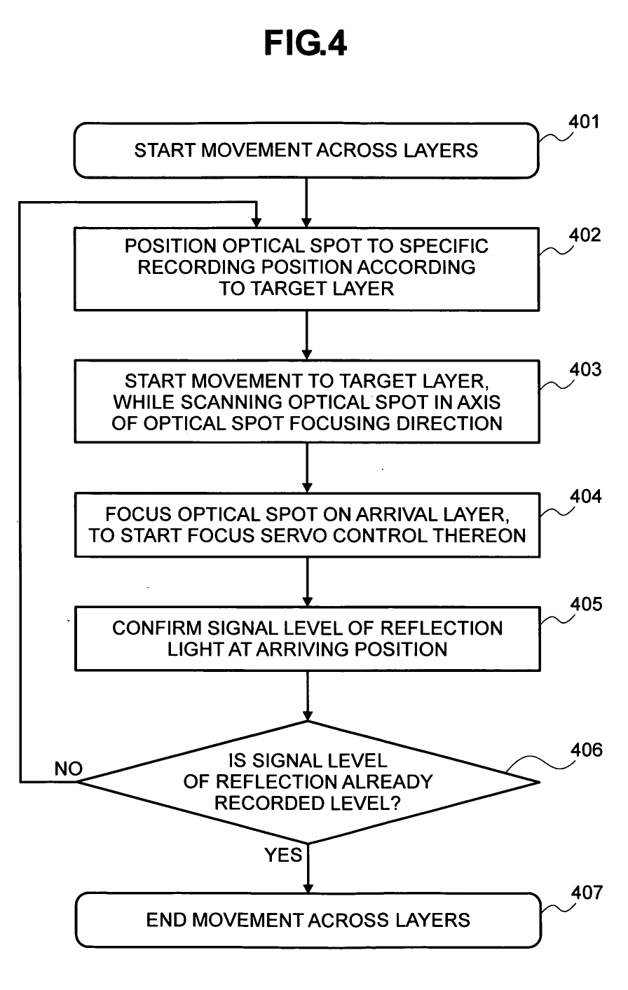

Mentioning will be made on an example of the method for moving across layers and the method for determining layers, by referring to a flowchart shown in FIG. 4.

First of all, the drive control system 302 manages the recording radial direction positions 107, 108, 109 and 110 on every layers, where the characteristic recording is done in advance, and when starting the movement across layers (a process 401), it positions the recording/reproducing element 304 at the radial direction position where the recording is made on a layer to be target (a process 402). And, it moves the recording/reproducing element 304, directing to the target layer, i.e., into the direction of an axis of an arrow 307 (a process 403), and further bring the recording/reproducing element to focus on the arrival layer (a process 404). As a method for focusing, in general, the focusing is achieved relying on the “S”-shaped curve of a focus error signal, as was mentioned in the background arts, but there is no necessity of adhering to a specific one of the methods, in particular. After obtaining the focusing, confirmation is made on a signal level of reflection light on the optical disc medium 301, i.e., are turning light into the recording/reproducing element 304 (a step 405). If the arrival layer is the target layer, since that radial direction position is in the condition of being already recorded, then the signal level of the reflection light is of the level of being already recorded. On the contrary, if the signal level of the reflection light is at a signal level of the condition of non-recording, then it can be seen at that instance that it fails in the movement across layers, and then can shift into a retry process (a process 406) Herein, in case when it is possible to confirm that it reaches to the target layer, the movement across layers is finished (a step 407). In this manner, according to the present invention, if the optical spot of the laser 305 is focused, it is possible to determine it is the target or nor, upon basis of the level of reflection light, and it is possible to omit or remove the time-period up to the time when the servo is stabilized through the tracking control of the recording/reproducing element 304, as was in the conventional art.

As a method for the drive control system 302 to manage the recording radial direction positions 107, 108, 109 and 110 may be remained addresses of those recording radial direction positions on the disc, as the data thereof. A position for reserving that address information may be an area or region where the optical disc drive can use, uniquely, on the optical disc medium.

Listing up an example thereof, for instance, on a medium of Blue-ray Disc Rewritable, there are prepared areas or regions, being called “Drive Area”, on an inner periphery or an outer periphery of the disc, as the areas that the optical disc drive apparatus can record unique data therein. In case when applying the present invention, in particular, onto the medium of Blue-ray Disc Rewritable, it is enough to record the address information of the recording radial direction positions 107, 108, 109 and 110, n into the Drive Area during the time up to when discharging the optical disc medium, while managing the address information mentioned above by means of the drive control system 302, in advance. With this, it is possible to read out the address information registered, when using that optical disc medium, next time, and it is possible to execute the movement across layers, according to the present invention, with using the position where the characteristic recording is done in the previous time, but without conducting that characteristic recording, again.

In the present example is listed up the medium of Blue-ray Disc Rewritable, as an example, but the present invention should not be restricted only to that medium of Blue-ray Disc Rewritable.

With applying the present invention therein, because of no necessity of the tracking servo control in the disc radius direction, as shown by an arrow 306, it is possible to make confirmation on the target layer and the arrival layer, quicker than that with the conventional method. According to the present invention, since the confirmation can be made on the recording/non-recording condition in a desired radial direction, without conducting the tracking servo control, the certainty of the present invention is increased, by increasing the recording region in the disc radial direction, while recording the characteristic recording on each layer, covering over a large number of tracks.

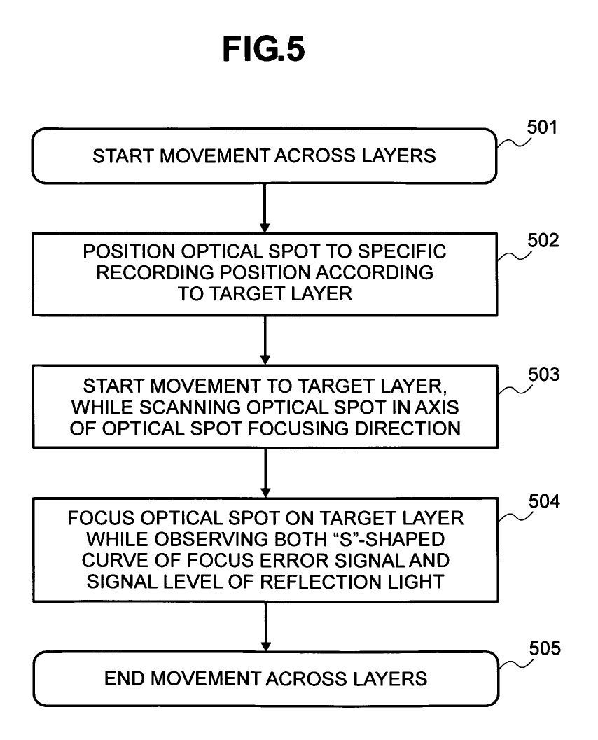

Also, in the example mentioned above, though the mentioning was med on the method of focusing relaying upon only the “S”-shaped curve of the focus error signal, as the method mentioned previously, when moving across layers, but by adopting the present invention, it is also possible to prevent an un-matching from generating between the target layer and the arrival layer. Thus, it is possible to increase the certainty of reaching to the target layer when the optical spot moves across the layers. The present example will be mentioned by referring to a flowchart shown in FIG. 5.

As a method, it is that of observing also the signal level of the reflection light, at the same time when observing the “S”-shaped curve, when moving the optical spot across the layers, in the similar manner to that of the conventional method. First of all, the recording/reproducing element 304 is positioned at the radial direction position where the recording is conducted on the layer to be the target (a process 502). Thereafter, for moving to the target layer, movement is started on the recording/reproducing element 304 in the axial direction shown by an arrow 307 (a process 503). During this movement, it is sufficient enough to execute the focus servo control, for fitting the focus position fitting to the “S”-shaped curve that exists when the signal level of the reflection light changes to the level of being already recorded, while observing on both, the “S”-shaped curve of the focus error signal and the signal level of the reflection light, at the same time (a step 504). With this, since it is possible to escape the optical spot from focusing on an erroneous layer, due to an error of counting up the number of the “S”-shaped curves, etc., then the useless re-try process can be omitted or removed from the processes for the movement thereof across layers. Furthermore, conducting the observations on both the “S”-shaped curve and the signal level of the reflection light, according to the present invention, even on the layers separated from, where deterioration may occur on the quality of the “S”-shaped curve, enables to increase the possibility of reaching to the target layer, once, jumping over the layers lying therebetween.

In this manner, it is possible to dissolve one of the problems to be dissolved by the present invention, i.e., determining an error between the target layer and the arrival layer, by applying the present invention therein, and it can be also expected to increase the processes for the movement across the layers themselves.

Next, mentioning will be made on a method for dissolving another problem, i.e., achieving the compatibility between the optical disc drive apparatuses, which are on sales on the market at present.

The present invention can be achieved by treating the characteristic recording at an arbitrary predetermined region of the disc, on each of the layers thereof, and by determining on the recording/non-recording condition at an arbitrary position within that predetermined region. For that reason, the predetermined region mentioned above is presumed to be in the condition of non-recording, originally, on all layers thereof, and therefore, after being treated thereupon the characteristic recording according to the present invention, it is necessary to keep that characteristic recording condition, for the purpose of conducting the movement across layers, with using that region thereafter, repetitively.

Then, for the purpose that the data recording operation cannot be made, within a portion of the predetermined region where that characteristic recording is treated, according to the present invention, registration is made on that region that, i.e., it is the area or region where the recording cannot be made, on the optical disc medium, logically. An example thereof will be shown in the below.

For example, on the medium of Blue-ray Disc Rewritable, there is established a system, wherein it is possible, for the optical disc drive apparatus, to register the area or region, having scratches or defects therein, on the optical disc medium, as a region where data cannot be obtained with stability, and that area or region registered is inhibited from being recorded by the optical disc drive apparatus. With using that defect management system, the region 102, in which the characteristic recording is conducted, according to the present invention, is registered into DFL (Defect List) provided for managing defect region. With this, the region 102, in which the characteristic recording is conducted, is registered, further, to be an area or region where the recording is impossible, logically. With this, the optical disc drive apparatus, after inserting the disc therein, will not conduct the recording in that registered region, since it can capture the defect region(s) through watching the DFL recorded on the disc.

With the drive enabling the present invention, explaining with using the example mentioned above, since there is the address information of the regions, where the characteristic recoding is conducted at the Drive areas thereof, it is possible to used that region for the purpose of conducting the movement across layers, in accordance with the address information registered in the Drive Area, even within the region that is registered as the defect region mentioned above.

With doing in this manner, other optical disc drive apparatuses must do only an operation for dealing with the case having defect(s) thereon, by consider the region where that characteristic recording is done to be the defect region, therefore there is no change occurring problems on the system. Also, since no recording is made in the region where the characteristic recording is done, it can be said that protection is made on the region where the characteristic recording is done, which is maintained for the present invention.

As was mentioned above, with registering the portion where the characteristic recording is done, to be the defect region, it is possible to achieve the compatibility, even with the optical disc drive apparatuses on sales on the market at present, but without a defect generated due to the present invention.

In the present example is listed up the medium of Blue-ray Disc Rewritable, as an example, but the present invention should not be restricted only to that medium of Blue-ray Disc Rewritable.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. An optical disc drive apparatus, for recording/reproducing upon/from an optical disc medium having a plural number of recording layers, comprising:
a recording/reproducing element, which is configured to irradiate a laser upon said optical disc medium, to as to conduct recording/reproducing thereon/from, wherein
recording is conducted within a region of an arbitrary range on said optical disc medium by means of said recording/reproducing element, and
said region is used for moving an optical spot of the laser irradiated from said recording/reproducing element when recording/reproducing data thereon/from.

2. The optical disc drive apparatus, ad described in the claim 1, wherein
said region is used for registering that it is a region where recording cannot be made, logically, on the optical disc.

3. The optical disc drive apparatus, ad described in the claim 1, wherein
said region is disposed within a region in a specific radial direction of the optical disc, equally, on every layer thereof.

4. The optical disc drive apparatus, ad described in the claim 1, wherein
address information of said region is recorded to be data on said optical disc medium.

5. The optical disc drive apparatus, ad described in the claim 3, wherein
said region is provided at radial direction position, differing from each other, on each of layers.

6. The optical disc drive apparatus, ad described in the claim 1, wherein
the movement across layers is conducted when recording/reproducing the data thereon/from, by using difference as an index, between signal levels of reflection lights at a position where the recoding is made and at a position where no recording is made, within said region.

7. An optical disc drive apparatus, for recording/reproducing upon/from an optical disc medium having a plural number of recording layers, comprising:
a recording/reproducing element, which is configured to irradiate a laser upon said optical disc medium, to as to conduct recording/reproducing thereon/from, wherein
recording is conducted within a range of an arbitrary range on said optical disc medium by means of said recording/reproducing element, and
said region is used for determining on whether the layer to be a target is a layer or not, at which an optical spot actually arrives, when moving the optical spot of the laser irradiated from said recording/reproducing element when recording/reproducing the data thereon/from.

8. The optical disc drive apparatus, ad described in the claim 7, wherein
difference between signal levels of reflection lights at a position where the recoding is made and at a position where no recording is made, within said region, is used as an index, for determining on whether the layer to be a target is a layer or not, at which an optical spot actually arrives.
